(19) United States
(12) Patent Application Publication
(10) Pub. No.: US 2006/0168102 A1
(43) Pub. Date: Jul. 27, 2006

(54) Cooperation between web applications

(76) Inventors: David Faller, Jettingen (DE); Peter Fischer, Kronach (DE); Carsten Leue, Sindelfingen (DE); Thomas Schaeck, Achern (DE)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/325,586

(22) Filed: Jan. 4, 2006

(30) Foreign Application Priority Data
Jan. 11, 2005 (EP) 05100122.0

(51) Int. Cl. G06F 15/16

(52) U.S. Cl. 709/217

(57) ABSTRACT

To provide flexible cooperation between web applications such as portlets. A first web application sends a request via a request dispatcher to a second web application. The second web application returns a response, to the first web application via the request dispatcher, enabling the first web application to display the second web application's response. In preferred embodiments, the second web application is remote.

### FIELD OF THE INVENTION

The present invention relates to web applications, particularly to the cooperation between web applications.

### BACKGROUND

Portals are an example of web service aggregating applications, which are special kinds of web applications that aggregate content or aggregate web applications from different sources. They serve as a simple, unified access point to web applications. Furthermore, portals provide functions like security, search, collaboration, and workflow. A portal delivers integrated content and applications, plus a unified, collaborative workplace.

Web applications aggregated by a portal are typically implemented as portlets. The term “portlet” refers to a small portal application, usually depicted as a small box in a web page. Portlets are reusable components that provide access to applications, web-based content, and other resources. Web pages, web services, applications, and syndicated content feeds can be accessed by portlets. Any particular portlet may be developed, deployed, managed, and displayed independently of other portlets.

A portlet is a complete application, following a standard model-view-controller design. Portlets have multiple states and view modes, plus event and messaging capabilities. Portlets run inside the portlet container of a portal server, similar to a servlet running on an application server. The portlet container provides a runtime environment in which the portlets are instantiated, used, and finally destroyed. Portlets rely on the portal infrastructure to access user profile information, participate in window and action events, communicate with other portlets, access remote content, lookup credentials, and to store persistent data. The portlet API provides standard interfaces for these functions.

A commonly used specification for invoking remote services in portals is WSRP (Web Services for Remote Portlets). In WSRP, a producer hosts a remote web service that is typically interactive. The consumer represents the entity integrating the remote service, e.g. a portal, whereas the end user is the person that comes to the consumer's web site to use the producer's application in the consumer's context.

At present, cooperation of two different web applications is not optimal. If the second of the web applications, to be invoked by the first web application, is remote, normally the second web application will itself display the response to a request of the first web application without integration into the consumer's context. For local web applications, cooperation is made possible via local APIs (application program interfaces) in terms of exchange of data, a process also called “wiring” in case of portlets.

Published U. S. patent application 2004/0090969 A1 enhances cooperation between portlets by providing a data sharing method. It allows creating a portal page that includes a first portlet and a second portlet, wherein a source field in the first portlet is mapped to a destination field in the second portlet so that the data in the source field is automatically shared with the destination field. This system is static in that destination and source field as well as the mapping have to be defined in view of possible functions and cooperation of the portlets. Thus, only data categories that were expected to be needed by more than one portlet can be accommodated.

### SUMMARY

A first aspect of the present invention includes a method for providing cooperation between two or more web applications, wherein a first web application sends a request via a request dispatcher to a second web application, and the second web application returns a response to the first web application via the request dispatcher, enabling the first web application to display the second web application's response.

Using a request dispatcher as “intermediary” allows for a flexible mode of cooperation. When the first web application needs some input other than from the end user, it may submit a request accordingly to the request dispatcher. The request dispatcher invokes a second web application capable of returning an appropriate response. Unlike the first web application, the request dispatcher always has the same interface, independent of whether a local or remote second web application is to be invoked. Unlike the second web application, the interface of the request dispatcher is such that the second web application does not need to take into account that the request originated from another web application. The request is received and processed like a conventional request. Consequently, neither the first web application nor the second web application has to be specially adapted to cooperate.

As the request dispatcher runs in the background, the end user does not necessarily notice that the second web application has been invoked.

In preferred embodiments of the present invention, the second web application is remote with respect to the first web application, and the request dispatcher performs a remote invocation of the second web application.

Preferably, the request dispatcher transmits information on the second web application's mark-up to enable the first web application to display the second web application's response. Otherwise it could happen that the display would be according to the environment of the server hosting the second web application, which could be different from the environment of the server hosting the first web application.

In preferred embodiments of the present invention, the web applications are implemented as portlets.

Advantageously, the request dispatcher is implemented according to the WSRP (Web Services for Remote Portlets) specification.

In a further aspect of the present invention, a web application is provided, having access to two or more further web applications and providing an application program interface arranged for forwarding a request of a first further web application to a second further web application, and forwarding the response of the second further web application to the first further web application such that the first further web application can display the second further web application's response.

In preferred embodiments of the present invention, the web application having access to two or more further web applications is a web service aggregating application.

The present invention can be realized in hardware, software, or a combination of hardware and software. Any kind of computer system, or other apparatus adapted for carrying out the methods described herein, is suited. A typical combination of hardware and software could be a general-purpose computer system with a computer program that, when executed, controls the computer system such that it carries out the methods described herein. The present invention can also be embedded in a computer program product, which comprises all the features enabling the implementation of the methods described herein, and which, having been loaded in a computer system, is able to carry out these methods.

Computer program means or computer program in the present context mean any expression, in any language, code, or notation, of a set of instructions intended to cause a system having an information processing capability to perform a particular functions either directly or after either or both of: conversion to another language, code or notation; or reproduction in a different material form.

### BRIEF DESCRIPTION OF THE DRAWINGS

In the following, preferred embodiments of the invention will be described in greater detail by making reference to the drawings in which:

FIG. 1 shows the architecture of a portal according to prior art;

FIG. 2 shows the architecture of a portal according to the present invention;

FIG. 3 shows schematically a first embodiment of the method according to the present invention;

FIG. 4 shows schematically a second embodiment of the method according to the present invention;

FIG. 5 is a flowchart illustrating a render-include flow; and

FIG. 6 is a flowchart illustrating an action-include flow.

### DETAILED DESCRIPTION

The present invention is explained below with reference to a portal with portlets. The communication between the portal or the portlets and remote services is based on WSRP (Web Services for Remote Portlets). Detailed explanations on WSRP may be found in a number of references, including http://www.ibm.com/developerworks/library/ws-wsrp, in the document “Specification: Web Services for Remote Portals (WSRP), Note 21 Jan. 2002” by Angel Luis Diaz, Peter Fischer, Carsten Leue, and Thomas Schaeck (WSRP has been renamed since 2002).

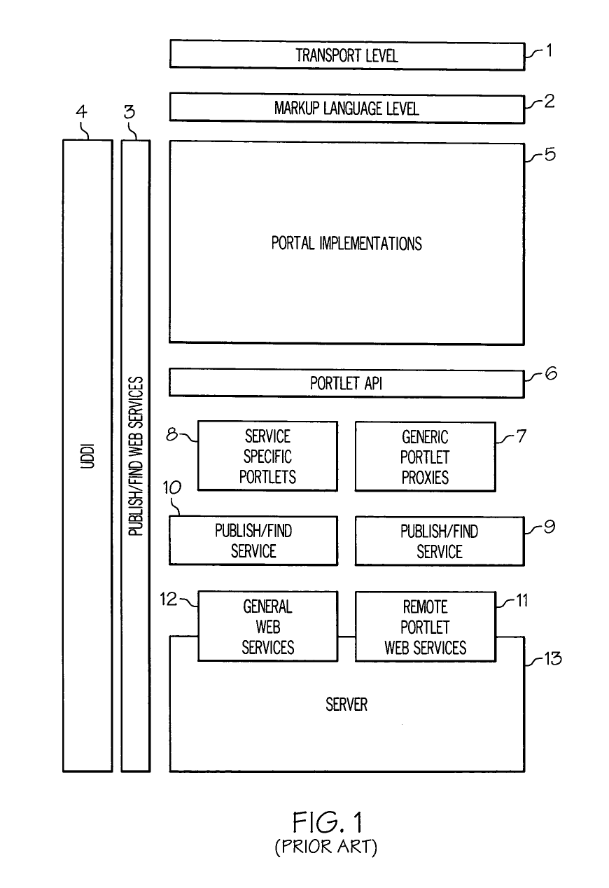

FIG. 1 shows the architecture of an open portal according to prior art, providing the possibility of using remote portlets as well as local portlets capable of using web services. The architecture shown assumes that the clients access portal implementations 5 via a transport layer like the HTTP protocol 1, either directly or indirectly through appropriate gateways, e.g. WAP gateways or voice gateways. The mark-up languages 2 used by the different devices may be different, for example WAP phones typically use WML, iMode phones use cHTML, and voice browsers mostly use VoiceXML, while the well-known PC web browsers use for example HTML.

When aggregating pages for portal users, portals typically invoke all portlets belonging to a user's page through a portlet API 6. There are two different kinds of portlets. Local portlets or service specific portlets 8 run on the portal server itself. They access general web services 12 via SOAP 10 on a web services platform 13. Remote portlets or remote portlet web services 11 run as web services on remote servers 13 that are published in UDDI directory 4 to allow for easy finding and binding 3. Typically, portlet proxies 7 (generic local placeholders) will invoke WSRP services to which they are bound via the SOAP protocol 9.

While portlets usually provide the base functionality for portals, remote portlets can provide a large number of additional functions without installation effort or need for third party code to run locally on the portal server.

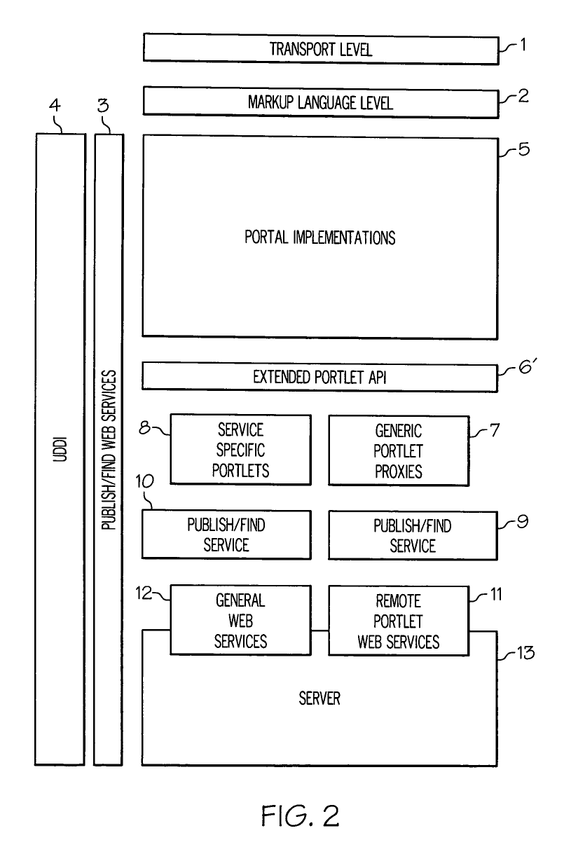

To embody the present invention, the portlet API 6′ may be extended, as shown in FIG. 2. The portlet API 6′ according to the invention provides a request dispatcher, which forwards a request from a first portlet to a second portlet, and forwards the response of the second portlet to the first portlet such that the first portlet can display the second portlet's response.

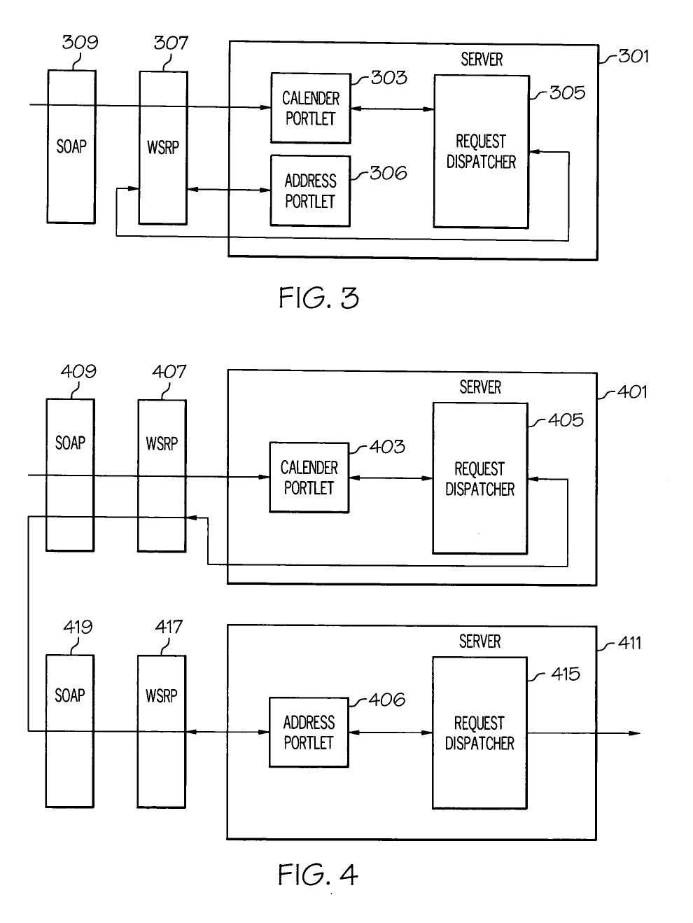

This is shown more in detail in FIGS. 3 and 4 with reference to a calendar portlet 303 or 403 and an address portlet 306 or 406. In the examples shown in FIGS. 3 and 4, the calendar portlet 303/403 is a remote portlet hosted on a server 301 or 401, and accessed by the end user's portal via SOAP 309 and WSRP 307.

The calendar portlet 303/403 decides whether it needs data on people that may be added to an invitation. The portlet 303/403 may itself search for an address portlet providing the necessary information, or may use special means of the server 301/401 for doing so. After it has found address portlet 306/406, it sends a request to the request dispatcher 305/405. The request dispatcher 305/405 forwards the calendar portlet's request either by a local invoke as shown in FIG. 3, where both portlets 303, 306 are hosted on the same server 301, or by a remote invoke as shown in FIG. 4, where the calendar portlet 403 and the address portlet 406 are hosted on different servers 401 and 411.

When forwarding the request, the request dispatcher 305/405 sends it via WSRP 307/407/417, even if the session is local as in FIG. 3. The response is also received via WSRP 307/407/417. In case of a remote session, the network is accessed via SOAP 409/419.

With reference to both portlets 303 and 306, the server 301 is a producer (hosting the address portlet 306) as well as a consumer (hosting the calendar portlet 303). With reference to the cooperation of portlets 403 and 406, server 401 is the consumer, and server 411 is the producer.

The special feature of the request dispatcher 305/405 is that it makes use of WSRP for receiving and forwarding requests and responses. Especially, the request dispatcher 305/405 enables the WSRP producer 301 to handle sessions from local calls, as shown in FIG. 3. The request dispatcher 305/405 also enables the WSRP consumer, in detail the protocol implementation, to invoke local WSRP calls (see FIG. 3). The request dispatcher 305/405 allows remote calls and handling of remote sessions between portlets, as shown in FIG. 4. The request dispatcher 305/405 “translates” communication on the local level into communication on the WSRP level, making available cooperation between local portlets as well as remote portlets.

As shown in FIG. 4, the cooperation can involve more than two portlets. If the address portlet 406 needs additional information as well to respond to the calendar portlet's 403 request, it can send a request to a further portlet via its own request dispatcher 415.

In addition to the request or response itself, the request dispatcher 305/405 also transmits the address portlet's markup to the calendar portlet to ensure display of the response, in this case the people to pick for the invitation. The information is submitted according to WSRP and includes, for example, user, session, device, markup, locale, and the like. The request dispatcher further provides URL generation for correct display. In local cases, the rewriting is done against the conventional local portlet API implementation. In remote cases, the rewriting is done against the WSRP specific portlet API implementation covering templates and WSRP rewrite URLs. In remote cases, the rewriting may be done in two steps, one on the WSRP level and one on the local level.

There ate two ways of invoking a portlet via the request dispatcher. It can be invoked during rendering of the calling portlet, which includes the markup of the called portlet, or it can be invoked during an action to the calling portlet, which forwards the action to the called portlet.

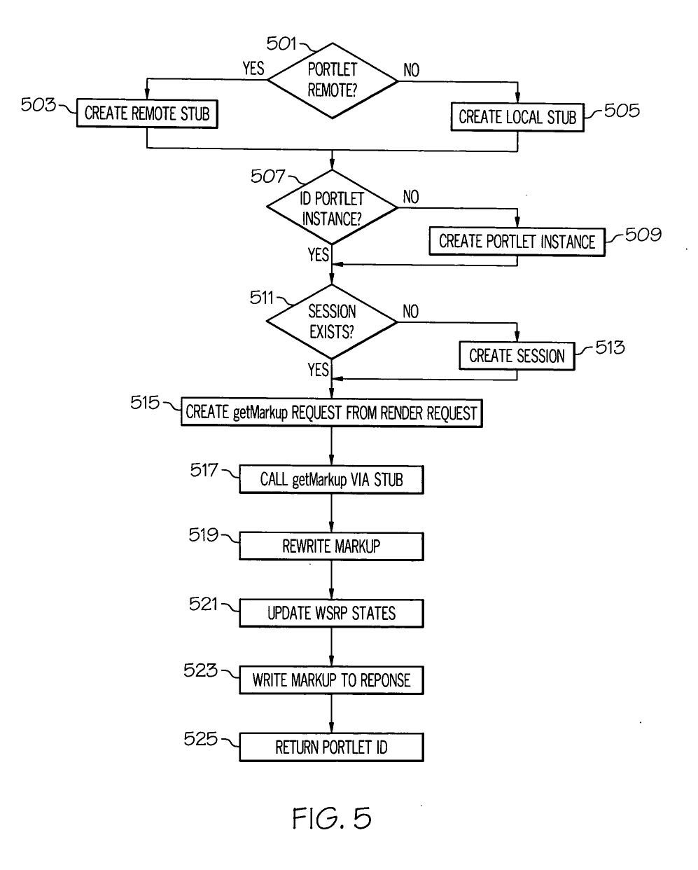

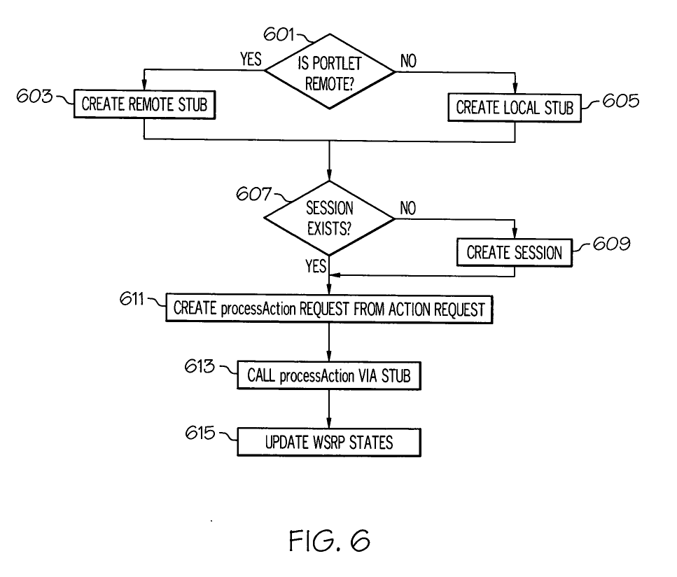

FIG. 5 is a flowchart illustrating the render-include flow. After checking whether the portlet to be called is remote or not (step 501), a remote or local stub is created (steps 503, 505). If it is the first call, an identifier for the portlet to be called is provided and a portlet instance and a session are created (steps 507, 509, 511, 513). A personalized instance can be created for the specific caller and a corresponding handle would be returned of the type “handle if not”. The returned handle must then be used for all subsequent calls that should invoke the same instance again. It is possible as well to create a personalized instance during rendering automatically. Only then an action would be allowed.

It will be noted that more explicit instance handling is possible.

Once the instance and the session exist, a getMarkup request is created from the render request (step 515) and the called via the stub (step 517). With this information, the markup is rewritten (step 519) and the WSRP states are updated (step 521). Then the markup is written to the response (step 523) and the portlet id is returned (step 525).

FIG. 6 is a flowchart showing an action-include flow providing the portlet's action request and response. A handle pointing to the portlet to be invoked, i.e. returned by the render include explained before, is provided. As in the render include flow, a check is made (step 601) to determine whether the portlet is remote or not, and a remote or local stub is created accordingly (steps 603, 605). If a session does not exist yet, a session is created (steps 607, 609). Once the session exists, a processAction request is created from the action request and called via the stub (steps 611, 613). After that, the WSRP states are updated (step 615). It is to be noted that the state will be modified by the called portlet, but no data will be returned explicitly.

We claim:

1. A method for allowing cooperation between two or more web applications, wherein a first web application sends a request via a request dispatcher to a second web application, the second web application returns a response, to the first web application via the request dispatcher, enabling the first web application to display the second web application's response.

2. The method of claim 1, wherein the second web application is remote with respect to the first web application and the request dispatcher performs a remote invocation of the second web application.

3. The method of claim 1, wherein the request dispatcher transmits information on the second web application's mark-up to enable the first web application to display the second web application's response.

4. The method according to claim 1, wherein the web applications are implemented as portlets.

5. The method according to claim 1, wherein the request dispatcher is implemented according to the Web Services for Remote Portlets specification.

6. A web application having access to two or more further web applications and providing an application program interface arranged for forwarding a request of a first further web application to a second further web application, and forwarding a response of the second further web application to the first further web application such that the first further web application can display the second further web application's response.

7. The web application according to claim 6, wherein the web application is a web service aggregating application.

8. A computer program product for allowing cooperation between two or more web applications, the computer program product comprising a computer readable medium having computer readable program code tangibly embedded therein, the computer readable program code comprising computer readable program code configured to send a request from a first web application to a second web application via a request dispatcher, and to return a response, from the second web application to the first web application via said request dispatcher, enabling the first web application to display the second web application's response.
